(19) United States
(12) Patent Application Publication
(10) Pub. No.: US 2011/0251977 A1
(43) Pub. Date: Oct. 13, 2011

(54) Ad Hoc Document Parsing

(76) Inventors: Michal Cialowicz, Boston, MA (US); Vanessa G. Ferranto, Boston, MA (US); Jonas Burton, Melrose, MA (US); Todd Brown, Boston, MA (US)

(21) Appl. No.: 12/759,315

(22) Filed: Apr. 13, 2010

(51) Int. Cl. G06Q 40/00; G06F 17/27; G06Q 10/00; G06F 3/01; G06F 17/00

(52) U.S. Cl. 705/36 R; 715/760; 715/234; 705/342; 704/9

(57) ABSTRACT

A system for analyzing investment related documents permits users to upload documents to software hosted on a server. The software identifies the mention of entities and user-defined themes, and calculates the sentiment of the mentions for reporting to the user. The software further analyzes particular documents such as by rating analyst reports.

### FIELD OF THE INVENTION

The present teachings relate to automated document analysis and, more particularly, automated analysis of investment-related documents to help investment professionals make investment decisions.

### BACKGROUND OF THE INVENTION

Investment professionals are overwhelmed with investment advice. They receive large amounts of news from a variety of sources. The sheer volume of information overloads the average investment professional. In addition, professional analyst reports and other types of investment-related documents are often drafted in such a way as to obscure their sentiment within innocuous language. This makes the investment professional's job difficult as they are then forced to read through massive amounts of information in order to make their own determinations regarding a particular investment opportunity.

Although tools have been created that identify sentiment (e.g., a positive or negative rating, etc.) in information harvested from news and blogs found on the Internet, they are typically geared toward marketing professionals and used for public relations purposes. In addition, existing tools do not permit the ability to upload documents; much less have the ability to parse specialized investment-related documents for useful investment information.

Therefore, it would be beneficial to have a superior ad hoc parsing system and method of use.

### SUMMARY OF THE INVENTION

The needs set forth herein as well as further and other needs and advantages are addressed by the present embodiments, which illustrate solutions and advantages described below.

The system of the present embodiment includes, but is not limited to, a database and receiving software having a graphical user interface for receiving from a user a plurality of investment-related documents and metadata relating to the plurality of investment-related documents. Processing software may process the plurality of investment-related documents by: identifying text found in the plurality of investment-related documents; identifying company mentions in the identified text; determining company mention sentiment for the company mentions; identifying theme mentions in the identified text; and determining theme mention sentiment for the theme mentions. Storing software may then store the identified mentions and determined sentiments in the database and reporting software may display the identified mentions and determined sentiments to the user and provide drill-down functionality from the identified mentions to the plurality of investment-related documents.

Other embodiments of the system and method are described in detail below and are also part of the present teachings.

For a better understanding of the present embodiments, together with other and further aspects thereof, reference is made to the accompanying drawings and detailed description, and its scope will be pointed out in the appended claims.

### BRIEF DESCRIPTION OF THE DRAWINGS

FIG. 1 is a block diagram depicting one embodiment of the system according to the present teachings;

FIG. 2 is a screen shot depicting one embodiment of the graphical user interface for the reporting software according to the present teachings;

FIG. 3 is a flow chart depicting one embodiment of the receiving (upload) software according to the present teachings;

FIG. 4 is a flow chart depicting one embodiment of the processing software according to the present teachings;

FIG. 5 (broken into FIGS. 5A and 5B) is a flow chart depicting one embodiment of the pre-processing software according to the present teachings; and

FIG. 6 is a screen shot depicting another embodiment of the graphical user interface for the reporting software according to the present teachings.

### DETAILED DESCRIPTION OF THE INVENTION

The present teachings are described more fully hereinafter with reference to the accompanying drawings, in which the present embodiments are shown. The following description is presented for illustrative purposes only and the present teachings should not be limited to these embodiments. Any computer configuration and architecture satisfying the speed and interface requirements herein described may be suitable for implementing the system and method of the present embodiment.

Intelligence tools are known in the marketing field for analyzing traditional news as well as new media sources. They are typically used to scan and interpret the many opinions found at the intersection of social and traditional media on the Internet. There is simply too much information available today to permit a person to absorb it all in any sort of meaningful way. As an example, intelligence tools may extract news and blog information from several thousand online sources, all which may generate content twenty-four hours a day.

Intelligence tools may collect many forms of content, organize and categorize it, and then provide a reporting mechanism to help users gain insights from relevant discussions. Such methodology may provide clear and simple metrics to identify messages, companies, brands and spokespeople that are driving the most media coverage. This is useful to identify the people, issues, and trends impacting business.

Providers of tools like these typically work with marketing, research and public relations (PR) professionals to address areas such as social media strategy, consumer opinions and trends, customer satisfaction, PR measurement, and reputation management. They can act as both a media monitoring service in order to identify trends, as well as to quantify PR and marketing initiatives for clients.

These tools may comprise natural language processing (NLP) capabilities, such that found in software offered by Lexalytics, Inc. and discussed further below, for identifying the mention of companies and user-defined themes, and then rate any mentions as positive or negative. Analysis can be automatically performed by software and delivered to users at near-real-time speed.

Such functionality is useful in the investment field since any trends identified in news and social media content may also affect stock price and investment objectives. This is powerful functionality for an investment professional since completing a timely trade can make the difference between the success and failure of a trade. It has been shown that markets exhibit momentum when it comes to positive or negative news affecting an investment. Therefore, it is preferable to be on the leading edge of any momentum shift. By determining sentiment of entities (e.g., companies, people, etc.) and themes (e.g., industries, markets, geographies, governments, etc.), an investment professional is given powerful information to make informed investment decisions.

Many documents are generated in the investment field. These include, but are not limited to, sell-side research reports, earnings and corporate event transcripts, earnings and corporate event briefs, SEC filings (e.g., 10Qs, 10Ks, etc.), market commentaries, stock surveillance reports, press releases, product release summaries, news stories, whitepapers, annual reports, and analyst reports. Until now, there has not been a service that provides automated analysis of such documents in order to rate company- and theme-specific sentiment. Therefore, it is desirable to extend analysis capabilities to the investment field and, in particular, to the analysis of investment-related documents provided by users of the system. For example, analyst reports and conference call transcripts, although not limited thereto, may contain important sentiment regarding the direction or value of a particular investment.

In the system described herein, NLP software may be installed on a server and provided with a front end graphical user interface to allow users to upload their investment related documents. The system may then submit the uploaded documents to the NLP software for analysis, and provide robust reporting capabilities through the general user interface.

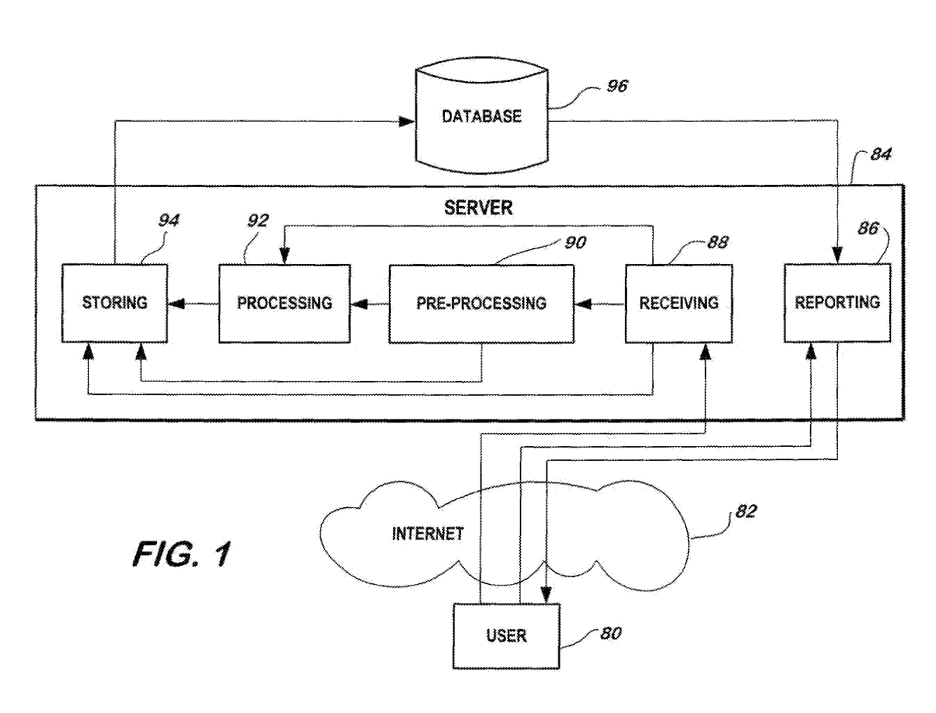

Referring now to FIG. 1, shown is a block diagram depicting one embodiment of the system according to the present teachings. As will be describe in detail below, a user 80 may access a server 84 through a network such as the Internet 82, although not limited thereto. The server 84 may have software executing on computer readable medium for performing the following tasks, although not limited thereto: receiving 88, preprocessing 90, processing 92, storing 94, and reporting 86. The server 84 may be in communication with a database 96 that stores document information and then provides the information to the reporting software 86 for reporting to the user 80.

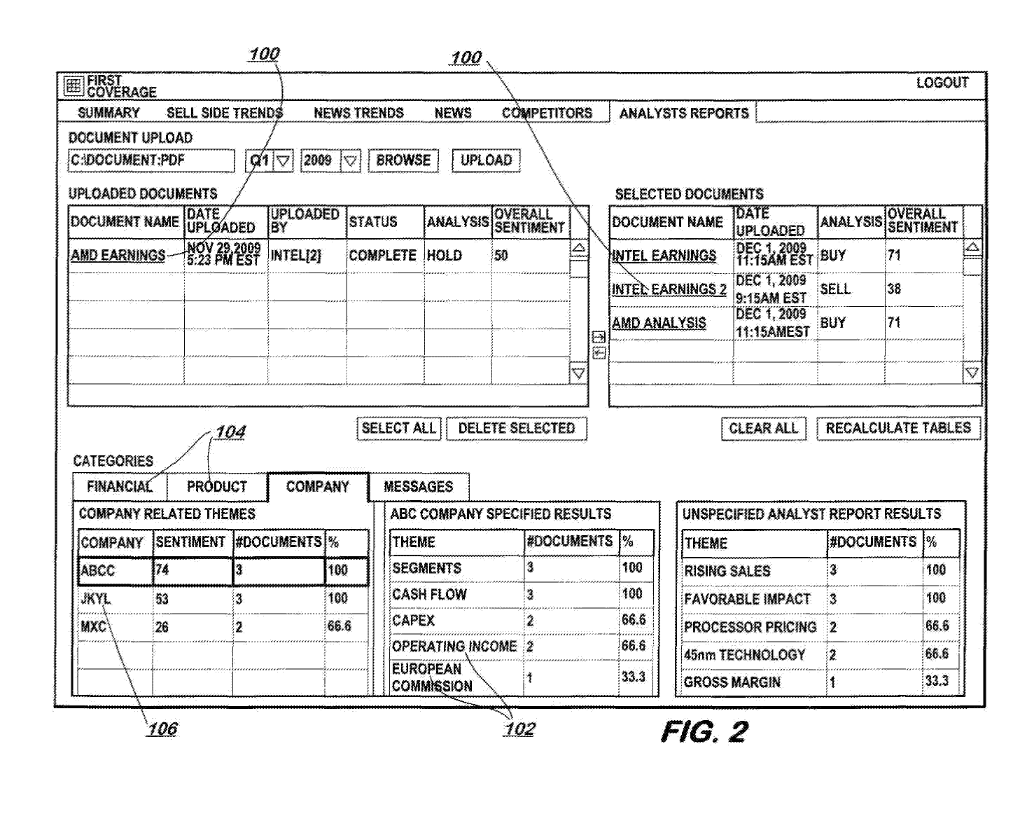

Referring now to FIG. 2, shown is a screen shot depicting one embodiment of the graphical user interface for the reporting software 86 (shown in FIG. 1) according to the present teachings. The graphical user interface may also provide the ability to upload documents, as shown. In one embodiment, although not limited thereto, a user may create user-defined themes 102 which the system will use to identify theme-specific sentiment. The user may organize themes in a number of categories 104, although not limited thereto. For example, a user may create a “Financial” category which may have a “European Commission” theme. The theme 102 may act as a label for an underlying query which may look something like: ec OR “european commission” OR eu OR “european union”, although not limited thereto. In this way, as the system analyzes an uploaded document 100 it may use the theme query and identify “European Commission” theme sentiment, discussed further below. The theme results may also be displayed in a company-specific fashion, such as by showing all theme mentions for a selected company, as shown.

The NLP software incorporated by the system disclosed herein may automatically identify people, companies, places, products, and dates, although not limited thereto. These may come from predetermined lists defined by a user or some other entity. For example, although not limited thereto, company names may come from a list of companies on a particular stock exchange. In this way, the software can associate company names to their ticker symbols for easy identification by users. The reporting software 86 may provide a company tab which displays companies 106 mentioned in any uploaded or Internet-based content, although not limited thereto.

In one embodiment, the ad hoc document parsing system may be accessed by a user through a website front end, although not limited thereto. As shown in FIG. 1, the user 80 may access software hosted on a server 84 through a network such as the Internet 82, although not limited thereto. Web-based software is known to provide many benefits, including simplified access to remotely-hosted data without the need to make large infrastructure investments on the client side. A user may log on to a secure site by providing authentication information such as a username and password, although not limited thereto. Users may be associated with each other by a client. In this way, client XYZ may have an account on the system with any number of users. If one user belonging to client XYZ uploads a document, that document and its analysis may immediately be made available to other users of client XYZ. In the alternative, the system may have a permissions system whereby users are assigned permission to view only certain documents, which may be categorized by any number of different ways.

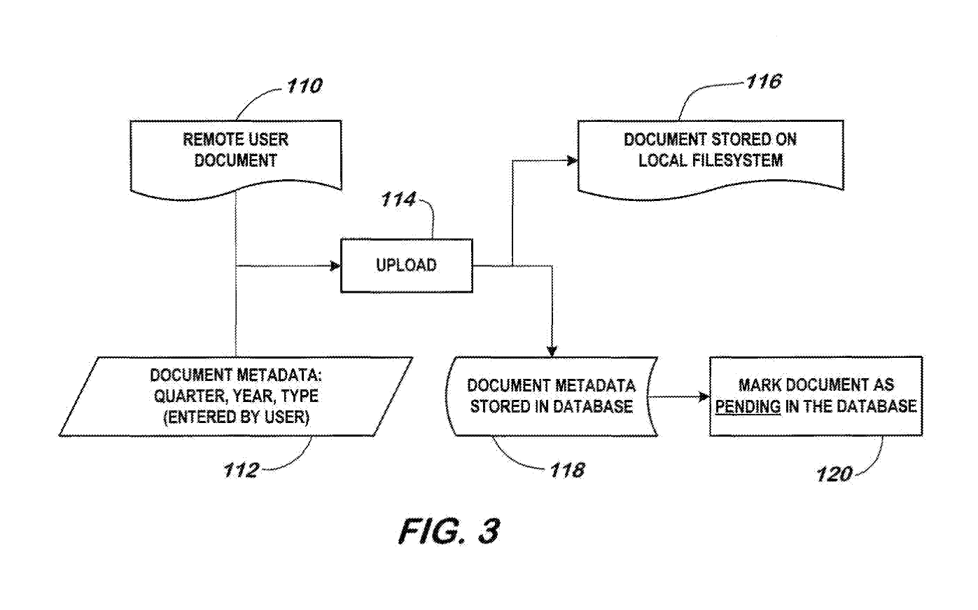

Referring now to FIG. 3, shown is a flow chart depicting one embodiment of the receiving (upload) software 88 (shown in FIG. 1) according to the present teachings. Specialized software may allow a user to select an entire folder of remote user documents 110 from the user's local machine, although not limited thereto, which are then uploaded 114 to the system for storage on the server 116 and marked as pending 120 for processing. The results of the processing may then be made available for reporting to any number of collaborative users. In such a way, the system may be made available 24/7, allowing each user to upload documents as they become available and making their analysis available to other users.

Metadata 112 may be input into the system by the user when documents are uploaded in order to help the system identify certain document characteristics. For example, although not limited thereto, the user may provide the document type, which may be useful for the system to determine whether to conduct any pre-processing, discussed further below. The user may also provide document title, name, author, and date (e.g., year, quarter, etc.). It is appreciated that the system may collect any number of pieces of data relating to uploaded documents and the present teachings are not limited to this particular embodiment. The metadata 112 may be stored in the database 118 for reporting to the user.

It is appreciated that receiving software 88 is known in the art and any software that is capable of satisfying these requirements may be used in the system described herein. Such software typically will receive a document or documents from a user 110 and transfer (copy) them to a folder residing on the server 116. The software may at the same time create a record in a database with information about the uploaded document, including its name, size, upload time, etc. In operation, the receiving software 88 may receive a document 110 and metadata 112 from the user, upload 114 the document to the system for local storage on the server's file system 116, store the metadata in the database 118, and mark the document record in the database with “Pending” 120 or some other label so the system knows that it is ready for processing. Specialized software may monitor the database to see if any recently uploaded documents are ready for processing. In one alternative, it may monitor the uploaded documents folder for the existence of any recently uploaded documents. The software may then pass these documents to other software for analysis.

As discussed above, NLP software has been used in the past to parse news and other content found on the Internet. In the investment field, the system may monitor blogs and mainstream media avenues, although not limited thereto, in order to tag articles that mention specified firms and/or business-related themes, and associate positive or negative sentiment to those mentions. The system may classify and categorize the sentiment and even detect themes and frequently mentioned phrases across multiple sources to identify trends.

Referring again to FIG. 2, investment-related documents may be categorized by the system based on queries which search document text for word combinations. For example, a user may want a document to be categorized in a “Financial” category 104 under a “growing costs” theme 102 if it contains the words “executive compensation” within two words of “increases”. In another example, a user may want to include documents that mention “increased inventory” in the “growing costs” theme. Each document may be placed in more than one category when it is analyzed.

In this way, uploaded documents 100 may be automatically categorized according to user-defined requirements so that similar documents are grouped together. If, for example, a user wanted to view to all “growing costs” documents, he or she could do so by navigating to a single point of entry. In one embodiment, although not limited thereto, the system may provide a default set of categories 104 and themes 102, which may then be customized on a per client basis.

The Salience™ product offered by Lexalytics, Inc. provides a NLP engine which may be used with the system described herein, although it is appreciated that any number of NLPs may be used and the present teachings are not limited to this particular embodiment. On a high-level, the NLP accepts any sort of text and processes it to return the following, although not limited thereto: extracted entities (e.g., people, places, companies, quotes, products, etc.), along with sentiment, frequency of occurrences, and various metadata about each entity.

Using NLP software such as Salience™, the system may process uploaded documents and detect: 1) companies mentioned in the document; 2) themes (e.g., key word phrases, etc.) mentioned in the document; and 3) phrases in a document that it thinks are important, based on frequency, sentiment, or some other variable. The software may also provide summaries on both a document and entity level, although not limited thereto. This information may then be stored in a database and reported to users of the system through a web-based interface, although not limited thereto.

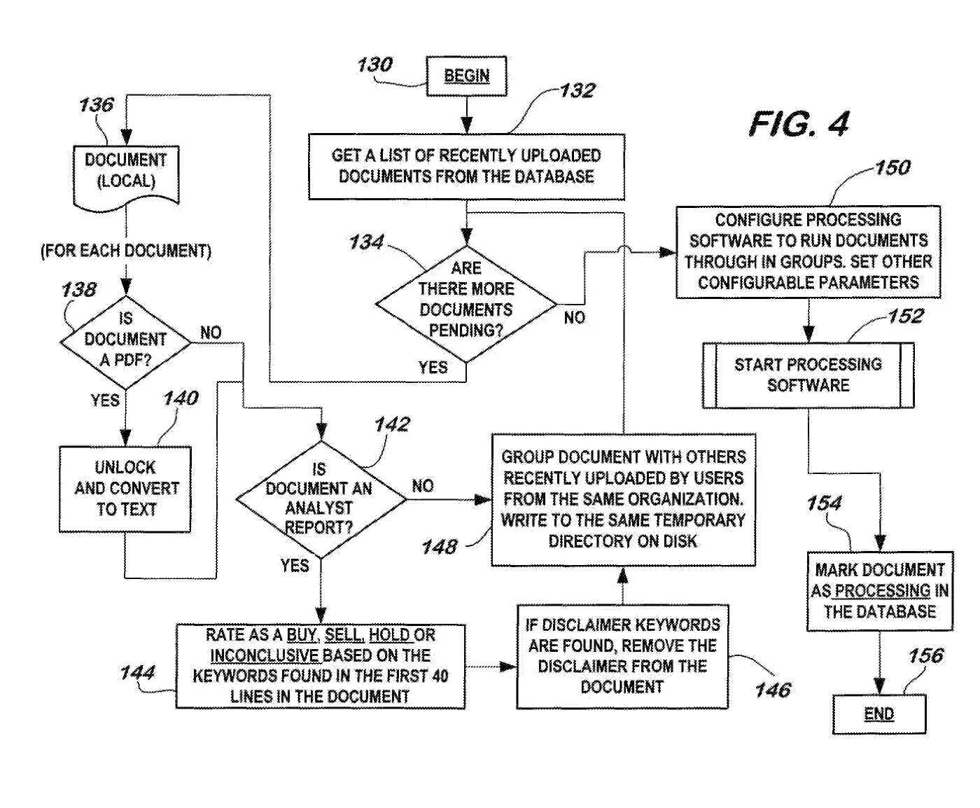

Referring now to FIG. 4, shown is a flow chart depicting one embodiment of the processing software 92 (shown in FIG. 1) according to the present teachings. The processing software 92, which may include NLP, performs a number of functions on each uploaded document. It may look at a database to determine if there are any recently uploaded documents 132 pending processing or, in one alternative, it may monitor a folder for the existence of documents to process. The system may identify and extract text 140 from the documents for analysis. It is appreciated that the text need not be extracted from an uploaded document for processing, and that identification of the text by itself may permit the software to then analyze the text. However, unlocking and/or converting the text 140 may be necessary in certain circumstances, such as when the documents are uploaded in a format that does not have readily-accessible text (e.g., .pdf, .tif, etc.).

The system may initiate pre-processing 90 (shown in FIG. 1) for analyst reports, discussed further below, and then initiate processing 92 when the documents are ready (e.g., no more documents pending 134, etc.). The processing software 92 may identify predetermined words or phrases in the identified text. For example, in one embodiment, the processing software 92 may identify company mentions and theme mentions. Next, the processing software may determine sentiment of those words or phrases. The Salience™ product by Lexalytics, Inc. provides this functionality and can be incorporated into the system. The Salience™ product offers integration through application program interfaces in a number of different programming languages.

To determine the sentiment of a document, the software may identify the parts of speech that indicate emotion, such as adjective-noun combinations, although not limited thereto. Once these phrases are identified, tone sentiment may be scored by determining how frequently a given phrase occurs near a set of good words (e.g. “good”, “excellent”, etc.) and a set of bad words (e.g. “bad”, “terrible”, etc.). The software may further identify these phrases in relation to specific people, companies, products, or other entities. This way, processing may identify both positive and negative sentiments in the same document that refer to different entities.

Once the identification of mentions and the determination of mention sentiment are complete, the system may have storing software 94 (shown in FIG. 1) for storing the identified mentions, phrases, and sentiment in a database. This allows the attributes of processed (e.g., analyzed) documents to be available for powerful reporting capabilities, discussed further below.

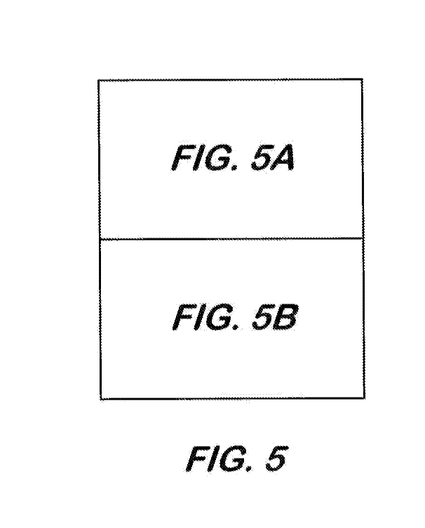

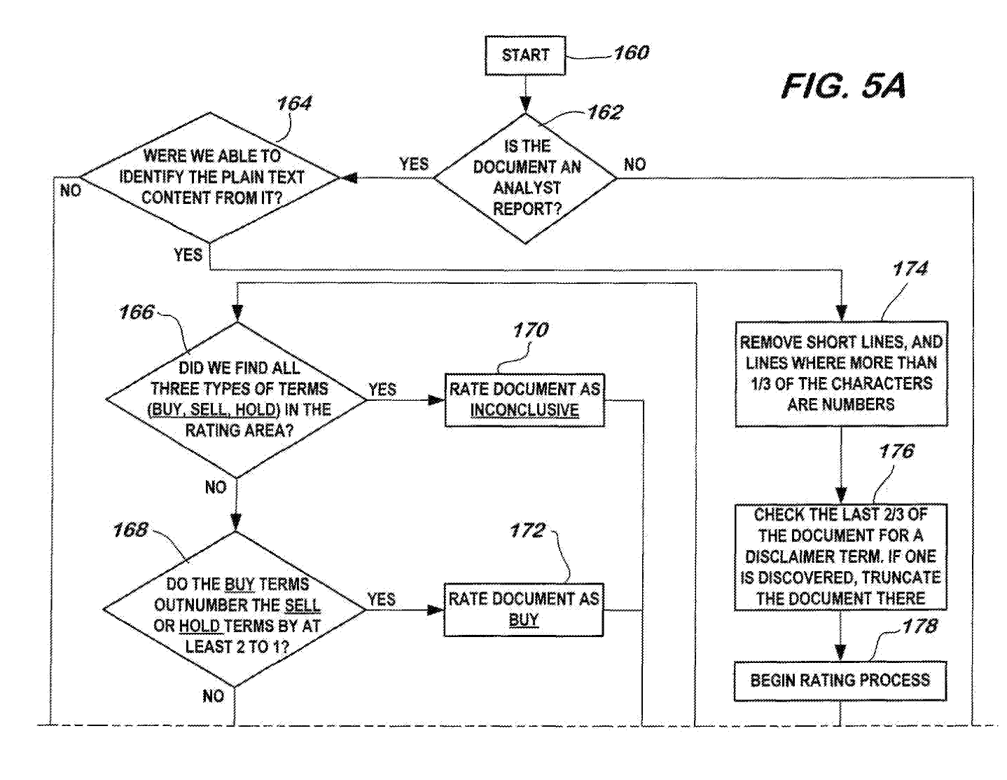

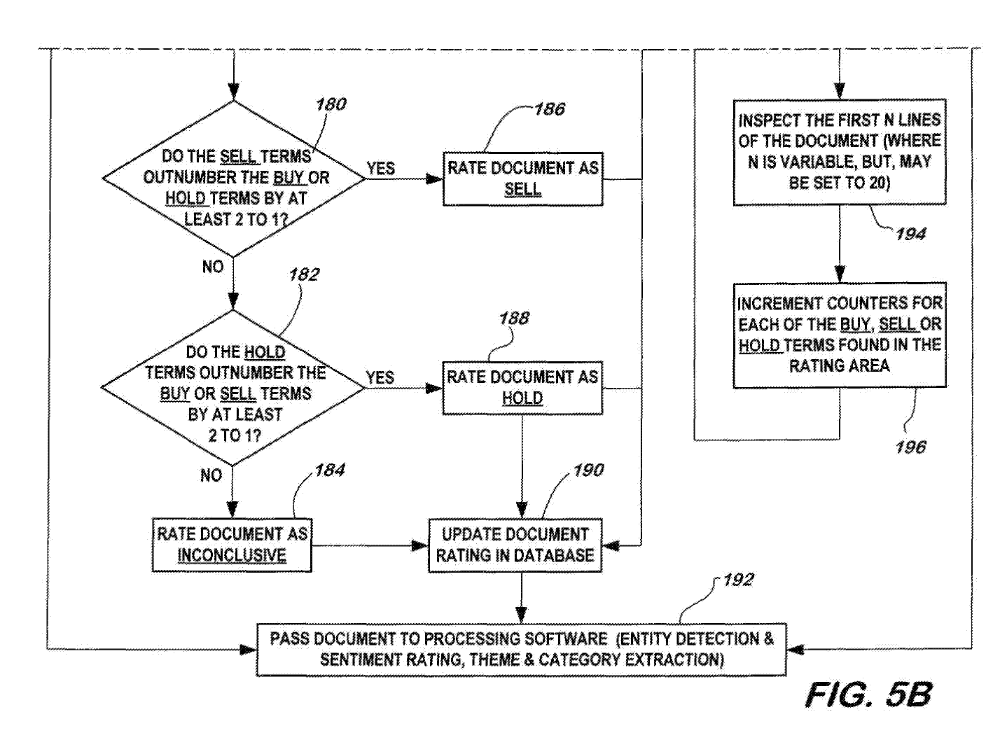

Referring now to FIG. 5 (broken into FIGS. 5A and 5B), shown is a flow chart depicting one embodiment of the pre-processing software 90 (shown in FIG. 1) according to the present teachings. The system may also provide processing (referred to as pre-processing 90) of certain documents prior to the identification of mentions and determination of sentiment by the processing software 92 discussed above. Analyst documents, for example, although not limited thereto, may contain particularized information for the investment professional which would preferably be analyzed separately. In one embodiment, although not limited thereto, analyst reports may be rated 170, 172, 186, 188 (e.g., buy, sell, hold, non-rated, etc.) by the pre-processing software 90. Documents suitable for rating may include analyst reports where each document mentions a single company that is rated as either a buy/hold/sell, although not limited thereto. Non-rated documents, on the other hand, may not mention a specific firm or take a position.

As discussed in the processing software 92 described above, the text may first be identified or extracted from the uploaded document for analysis. The pre-processing software 90 may determine rating information for each analyst report by looking at a predetermined portion of text (e.g., not including disclaimers and other unwanted or unnecessary text, although not limited thereto) to identify analyst rating terms. In one embodiment, the software may only search for rating terms in the first 20-50 lines, although not limited thereto.

The pre-processing software 90 may identify and remove or ignore a disclaimer 176. This permits it to only consider the most relevant text in the document. The software may search for predetermined words or phrases that tend to indicate the start of a disclaimer section. These may include phrases like “required disclosures,” “research disclosures,” “investor disclosures,” “analyst certification,” “methodology & disclaimers,” etc. If a user uploads multiple documents from a single source at once, the system may be able to identify disclaimer information 176 by similar language used in multiple documents. For example, if one portion of each document contains substantially the same language, this may indicate that the language is a commonly-used disclaimer.

The pre-processing software 90 may automatically identify and remove or ignore any predetermined unwanted or unnecessary text 174. This text may be removed or ignored in order to further isolate the rating content. Unwanted text may include, for example, although not limited thereto, data-tables, short lines of text, lines having over two-thirds numbers, etc.

In the predetermined portion, which in one embodiment may include the text exclusive of the disclaimer and unwanted text discussed above, the software may search for analyst rating terms which may include, although not limited thereto, the terms: BUY, HOLD, and SELL. If other terms are used, they may be associated or mapped to these terms in order to standardize the rating terminology and compare documents from multiple firms which may employ different rating systems.

Once the software identifies the occurrence of analyst rating terms in a document, it may rate 170, 172, 186, 188 the document based on their relative frequency. For example, it may rate a document “Buy” if the frequency of the term “Buy” outnumbers both “Sell” and “Hold” 168. Similarly, it may rate the document “Sell” or “Hold” if either of these terms occurs more than the others 180, 182. In another embodiment, the software may only rate a document if the analyst term frequency exceeds a predetermined ratio. For example, it may rate a document a “Buy” if it outnumbers both “Sell” and “Hold” 2-1 168. It is appreciated that any number of different ratios could be used to rate a document based on any number of different analyst rating terms and the present teachings are not limited to these particular embodiments.

Documents that are unable to be successfully rated may be tagged “inconclusive” or “non-rated” 170 and put into a queue for manual inspection and further processing, although not limited thereto. Once the pre-processing is complete, the rating information may be stored in a database 190 for reporting and the document may be sent to the processing software for further analysis 192.

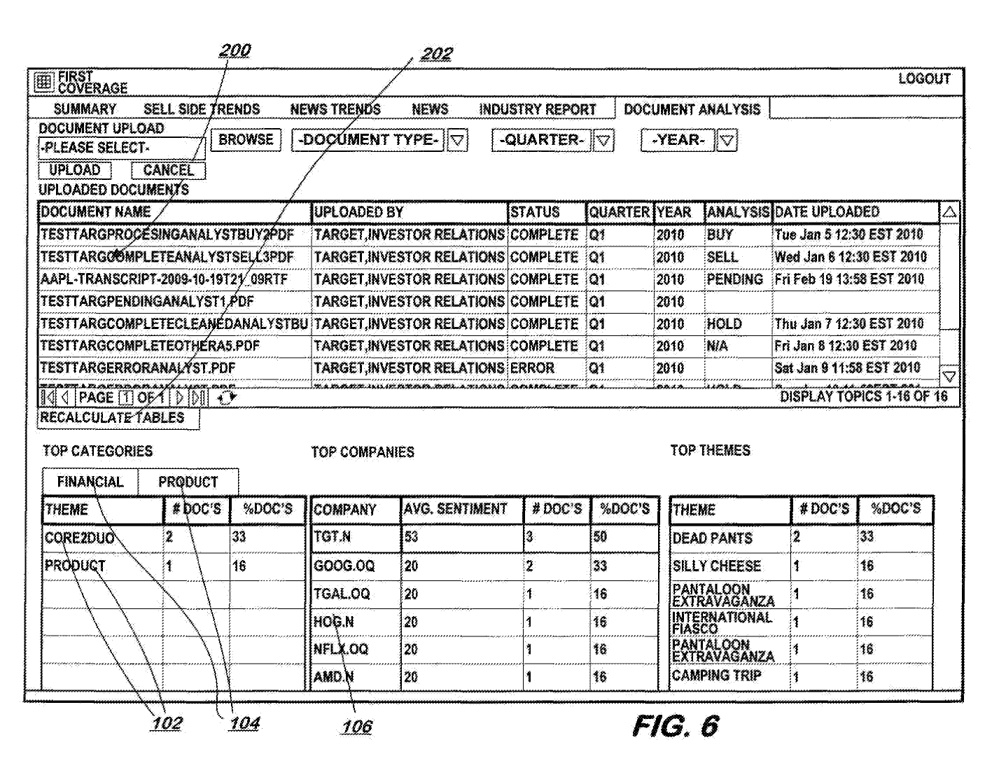

Referring to FIG. 6, shown is a screen shot depicting another embodiment of the graphical user interface for the reporting software 86 (shown in FIG. 1) according to the present teachings. As discussed above, the output from the pre-processing 90 and processing software 92 may be persisted in a database 96 for reporting through the graphical user interface. A user may be able to browse the library of uploaded documents and compare them against each other. Some examples of usage may include, although not limited thereto: 1) select all documents for the fourth quarter and see how many of them have the theme “growing costs”; 2) take the same research and compare their ratings to the long/short ratio of the sell side equity sales desk; and 3) identify unexpected key word phrases present within each document.

In one embodiment of the graphical user interface, a user can select multiple documents 200 in the “Uploaded Documents” table by holding the “Ctrl” key and clicking on them. Once a selection has been made, the user may click the “Recalculate Tables” button 202 to view the analysis information for these documents. In one embodiment, tables may display company 106 mentions, user-definable theme 102 mentions, and unspecified themes (e.g., automatically identified by NLP, etc.). For each of these (e.g., company, theme, etc.), the reporting software 86 may provide the number of documents in which they appear, the % of selected documents in which they appear, and the sentiment, although not limited thereto.

The categories 104 may be generated dynamically each time the user clicks the “Recalculate Tables” button 202, although not limited thereto. For example, if the user has three categories 104 set up in the system (e.g., Financial, Product, and Competitive) and the selected documents 200 only relate to two of those categories 104, then only those two will appear. If the user selects a new set of documents 200 that relate to all of the categories 104 and then clicks the “Recalculate Tables” button 202, then all three will appear.

Each table may be capable of being filtered and sorted. For example, filters may include, although not limited thereto, document attributes such as Uploaded By, Status, Quarter, Year, Analysis, Name, and Date. In one example, a user may only want to see documents that have been completely processed and have a status of “Completed,” or just documents from the year 2009. Any document attribute may also be used to sort table columns, although not limited thereto.

The reporting software 86 may provide analysis on a document by document basis as well as combined reporting capabilities on groups of documents. For example, the system may report on multiple documents filtered in any number of categories, themes, companies, etc. From there a user can drill down to the particular documents that contain these themes, company names, etc., and view the original uploaded document.

Users may also view sentiment (e.g., company, theme, etc.) over time or compare particular documents from year to year. For example, a user could compare a Q3 earnings call transcript with a Q4 call transcript and the system would identify common themes, categories, sentiment scoring, etc. in both documents in an easy-to-understand format. It may be helpful for the investment professional to determine the change in use of theme language or theme sentiment over time in order to identify trends.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A system for analyzing investment-related documents, comprising:
a database;
receiving software executing on computer readable medium, the receiving software having a graphical user interface for receiving from a user a plurality of investment-related documents and meta-data relating to the plurality of investment-related documents;
processing software executing on computer readable medium for processing the plurality of investment-related documents, the processing comprising:
identifying text found in the plurality of investment-related documents;
identifying company mentions in the identified text;
determining company mention sentiment for the company mentions;
identifying theme mentions in the identified text; and
determining theme mention sentiment for the theme mentions;
storing software executing on computer readable medium for storing the identified mentions and determined sentiments in the database; and
reporting software executing on computer readable medium, the reporting comprising:
displaying the identified mentions and determined sentiments; and
providing drill-down functionality from the identified mentions to the plurality of investment-related documents.

2. The system of claim 1, wherein the investment-related documents comprise at least one of: conference call transcripts, sell-side reports, earnings reports, analyst reports, corporate event briefs, SEC filings, press releases, annual reports, news, and whitepapers.

3. The system of claim 1, wherein the receiving software is hosted on a server and the graphical user interface is accessed by the user over the Internet.

4. The system of claim 1, wherein at least one of the themes is user-definable.

5. The system of claim 1, wherein the metadata comprises document type.

6. The system of claim 1, further comprising pre-processing software executing on computer readable medium for processing the plurality of investment-related documents, the pre-processing comprising:
identifying text found in the plurality of investment-related documents;
identifying disclaimer text in the identified text;
identifying predetermined unwanted text in the identified text;
identifying analyst rating terms in a predetermined portion of the identified text; and
determining rating information for the plurality of investment-related documents based at least in part on the identified analyst rating terms.

7. The system of claim 6, wherein the predetermined unwanted text comprises lines with less than ⅔ text and lines with over ⅔ numbers.

8. The system of claim 1, wherein the reporting software allows a user to filter the plurality of investment-related documents to show identified mentions in the filtered documents.

9. The system of claim 1, further comprising categories, wherein themes may be organized by categories.

10. The system of claim 1, wherein the reporting software allows a user to compare documents over time.

11. A system for analyzing investment-related documents, comprising:
a database;
receiving software executing on computer readable medium, the receiving software having a graphical user interface for receiving a plurality of investment-related documents from a user;
processing software executing on computer readable medium for processing the plurality of investment-related documents, the processing comprising:
identifying text found in the plurality of investment-related documents;
identifying analyst rating terms in a predetermined portion of the identified text; and
determining rating information for the plurality of investment-related documents based at least in part on the identified analyst rating terms;
storing software executing on computer readable medium for storing the rating information in the database; and
reporting software executing on computer readable medium for reporting the rating information to the user.

12. The system of claim 11, wherein the receiving software is hosted on a server and the graphical user interface is accessed by the user over the Internet.

13. The system of claim 11, wherein the investment-related documents comprise at least one of: conference call transcripts and analyst reports.

14. The system of claim 11, wherein the processing software further comprises:
identifying disclaimer text in the identified text; and
identifying predetermined unwanted text in the identified text;
wherein the predetermined portion of the identified text comprises text exclusive of the identified disclaimer and identified predetermined unwanted text.

15. The system of claim 14, wherein disclaimer text is identified by common language found in similar uploaded documents.

16. The system of claim 14, wherein the predetermined unwanted text comprises lines with less than ⅔ text and lines with over ⅔ numbers.

17. The system of claim 11, wherein the predetermined portion of the identified text comprises the first 20-50 lines of the identified text.

18. The system of claim 11, wherein the analyst rating terms comprise: Buy, Sell, and Hold.

19. The system of claim 18, wherein the processing software determines rating information as: Buy if Buy terms outnumber Sell or Hold terms, Sell if Sell terms outnumber Buy or Hold terms, and Hold if Hold terms outnumber Buy or Sell terms.

20. A system for analyzing investment-related documents, comprising:
a database;
receiving software executing on computer readable medium, the receiving software having a graphical user interface for receiving from a user a plurality of investment-related documents and meta-data relating to the plurality of investment-related documents;
processing software executing on computer readable medium for processing the plurality of investment-related documents, the processing comprising:
identifying text found in the plurality of investment-related documents;
identifying analyst rating terms in a predetermined portion of the identified text;
determining rating information for the plurality of investment-related documents based at least in part on the identified analyst rating terms;
identifying company mentions in the identified text;
determining company mention sentiment for the company mentions;
identifying theme mentions in the identified text; and
determining theme mention sentiment for the theme mentions;
storing software executing on computer readable medium for storing the identified mentions, determined sentiments, and determined rating information in the database; and
reporting software executing on computer readable medium, the reporting comprising:
displaying the identified mentions, determined sentiments, and determined analyst rating information; and
providing drill-down functionality from the identified mentions to the plurality of investment-related documents.

21. The system of claim 20, wherein the receiving software is hosted on a server and the graphical user interface is accessed by the user over the Internet.
